(19) United States
(12) Patent Application Publication
(10) Pub. No.: US 2007/0176394 A1
(43) Pub. Date: Aug. 2, 2007

(54) Semitrailer train with signal transformer coil

(75) Inventors: Ottmar Gehring, Kernen (DE); Harro Heilmann, Ostfildern (DE); Andreas Schwarzhaupt, Landau (DE); Gernot Spiegelberg, Heimsheim (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/576,083

(22) PCT Filed: Oct. 2, 2004
(86) PCT No.: PCT/EP04/11019

§ 371 Date: Oct. 26, 2006

(30) Foreign Application Priority Data
Oct. 14, 2003 (DE) 103 47 561.3

(51) Int. Cl. B60D 1/62

(52) U.S. Cl. 280/420

(57) ABSTRACT

A semitrailer train having a coupling part assigned to the towing vehicle and a coupling part assigned to the semitrailer. A control device for controlling components of the semitrailer is provided in the towing vehicle data lines transmit the control data and power supply lines to the components. The coupling part assigned to the towing vehicle is a fifthwheel pickup plate and the coupling part assigned to the semitrailer is a kingpin which matches said coupling part. An alternating voltage generator arrangement in the vehicle provides a modulated carrier signal and a transformer coil is arranged in the fifthwheel pickup plate of the towing vehicle in order to transmit the carrier signal with the control data modulated onto it to a transformer coil in the region of the kingpin of the semitrailer.

### BACKGROUND AND SUMMARY OF THE INVENTION

The invention relates to a semitrailer train including a towing vehicle, a semitrailer and a fifthwheel which has a coupling part assigned to the towing vehicle and a coupling part which is assigned to the semitrailer in order to form a mechanical connection between the towing vehicle and semitrailer. A control device controls components of the semitrailer and is provided in the towing vehicle. The semitrailer has data lines for transmitting the control data and power supply lines for supplying power to the components. The part which is assigned to the towing vehicle is a fifthwheel pickup plate and the coupling part which assigned to the semitrailer is a kingpin which matches the coupling part. The invention also relates to a towing vehicle which is suitable for use in the semitrailer train with wireless signal transformer coil, and to the semitrailer which is suitable for said towing vehicle.

In heavy trucks with semitrailers, referred to as semitrailer trains, components are increasingly activated electronically by means of control devices in the towing vehicle. Such components may be brake systems for the semitrailer, electrically operated air pressure systems and all the electrical actuators in the semitrailer. In addition, sensors for monitoring or diagnosing the semitrailer or the products transported therein can also be actuated by means of a control device in the towing vehicle. Such components are actuated in conventional semitrailer trains by means of control signals which are transmitted from the towing vehicle to the semitrailer via a wirebound line.

German Patent DE 197 03 144 C2 discloses a towing vehicle with a semitrailer which is equipped with a reversing aid which is controlled by the towing vehicle. If the truck moves backwards, a switch for the reversing light is closed and at the same time a display in the towing vehicle is supplied with voltage via the switch. The signals coming from the semitrailer to the reversing aid are then evaluated by means of a control device and transmitted to the display in the towing vehicle. The data is passed on in a serial fashion for display via a two-wire supply line. The towing vehicle is coupled to the semitrailer by means of plug-type connections. The signal for the reversing aid is modulated onto the electrical supply line of the reversing light, i.e. to the supply voltages, by means of a special modulation method. To do this, a frequency-shift-keying (FSK) method is proposed for modulation. In this way, the supply voltage of the reversing light effectively functions as a carrier signal onto which the different control data is modulated. The signals are output by the sensors of the reversing control device of the towing vehicle onto the supply line leading to the right-hand flashing indicator light, which line is connected to the flashing indicator light of the semitrailer. In this way it is possible to transmit the signal of the reversing aid into the towing vehicle on the already existing supply line and via the plug-type connector at the coupling between the towing vehicle and semitrailer, and said signal can be used for display purposes in the towing vehicle.

European Patent EP 0 425 766 B1 discloses an electronic brake controller for motor vehicles having a mechanical trailer hitch or fifthwheel with a standard plug-type connection for transmitting the electrical signals to the semitrailer. At the coupling interface between the towing vehicle and the semitrailer a plug is provided on one side and a socket on the other. They must be electrically conductively connected whenever the semitrailer is coupled to the towing vehicle. The necessary control signal for the brake system of the semitrailer is then transmitted via the coupling interface. Furthermore, a vehicle diagnostic system, which is capable of diagnosing at least the brake pressure controller, but if necessary also the electronic controller with the connected peripherals, is also provided in the semitrailer. For this diagnostic purpose, it is necessary for data to be exchanged between the diagnostic system of the towing vehicle and the brake pressure controller in the semitrailer. There is provision for data to be transmitted bidirectionally between the towing vehicle and the semitrailer via the plug-type connector, the messages being transmitted in the form of data blocks in a similar way to data buses.

In practice, the plug-type connectors between the towing vehicle and semitrailer often give rise to system faults in the semitrailer train. On the one hand, problems may arise in the formation of contact within the plug-type connector since said connector is usually used in a heavily soiled environment in the region of the fifthwheel of the semitrailer train. On the other hand, the plug-type connector must be manually coupled in many vehicles so that faults may also occur here. If automatic coupling of the mechanical plug-type connector occurs when the semitrailer train is coupled together, there is the problem that these plug-type connectors have to be also simultaneously coupled with the mechanical coupling of the semitrailer, during which process the contacts or the plug-type connector can be damaged.

German Patent Documents DE 100 33 345 A1 and DE 101 59 503 A1 discloses a wirefree electrical connection between the electrical functional devices of a trailer and the control device of a tractive unit.

German Patent Document DE 195 32 043 C2 and European Patent Document EP 0 616 924 A1 describe a device for inductively transmitting signals and energy which can be used, for example, between the fixed steering column and the steering wheel of a vehicle.

U.S. Pat. No. 6,222,433 B1 discloses a trailer hitch between a passenger car and a boat trailer. The two coupling parts which match one another are each provided with an induction coil whose axes are arranged parallel to the vertical direction. Both a carrier signal and a data signal can be transmitted by means of this wirefree transmission of signals to the boat trailer.

The object of the present invention is to provide an alternative transmission arrangement for a semitrailer train with a fifthwheel and a means of transmitting signals from the towing vehicle to the semitrailer in such a way that mechanical coupling of the electrical plug-type connector of the electrical lines can be dispensed with.

This object is achieved according to the invention by a fifthwheel which is assigned to the towing vehicle and a coupling part which is assigned to the semitrailer are provided in order to form a mechanical connection between the towing vehicle and semitrailer, the coupling part which is assigned to the towing vehicle being a fifthwheel pickup plate and the coupling part which is assigned to the semitrailer being embodied as a kingpin which matches the coupling part. A transformer coil is arranged in the fifthwheel pickup plate of the towing vehicle in order to transmit the carrier signal with control modulated data to a transformer coil in the region of the kingpin of the semitrailer. The transformer coil in the fifthwheel pickup plate of the towing vehicle is a coil whose linear or curved longitudinal axis is arranged essentially parallel to the plane of the fifthwheel pickup plate.

According to the invention, it has been recognized that energy for supplying power to a component in the semitrailer can be transmitted in a wirefree fashion by means of inductive coupling via the two transformer coils arranged on the semitrailer train. As a result, by inductive coupling of the type which occurs in a transformer coil, the supply current for the component in the semitrailer can be produced in the towing vehicle and transmitted to the semitrailer in a wirefree fashion. As a result, there is no need for a separate generator to be provided in the semitrailer in order to operate individual control devices with direct current or lamps or compressors for brake systems with alternating current. Since the inductive coupling takes place in a wirefree fashion between the two transformer coils, the voltage generator in the towing vehicle must generate a periodically fluctuating voltage since only alternating voltages can be input into the transformer coil on the semitrailer via the inductive coupling. The voltage generator in the towing vehicle can be used to generate a genuine alternating voltage with an alternating voltage sign such as is ensured, for example, by a sinusoidal function, or the periodically fluctuating energy signal is generated by superimposing alternating voltage and direct current so that the voltage fluctuates between zero potential and a positive potential. The transformer coil then induces a pure alternating voltage in the transformer coil on the semitrailer and, depending on the component which is to be supplied in the semitrailer, this alternating voltage is then rectified or, for example, lamps can also be actuated by alternating voltage.

As a result of the particularly advantageous transmission of energy from the towing vehicle to the semitrailer, a separate generator in the semitrailer can be dispensed with and it is additionally also possible to dispense with a plug-type connector between the towing vehicle and semitrailer since the energy is transmitted inductively between the towing vehicle and semitrailer.

In order to transmit the supply voltage from the towing vehicle to the semitrailer it is necessary for the voltage generator in the towing vehicle to generate, for example, a sinusoidal carrier signal on which, if appropriate, a direct voltage can be superimposed in order to generate a periodically fluctuating direct voltage signal. In the semitrailer it is then possible, if appropriate, to provide a rectifier which converts the power supply voltage which is transmitted by the transformer coil into direct current so that the component of the semitrailer can be supplied with direct voltage.

The object is also achieved according to the invention a signal modulator in the towing vehicle which modulates the control data onto the energy signal which functions as a carrier signal and transmits it to the first transformer coil in the region of the fifthwheel pickup plate of the towing vehicle. The carrier signal with the control modulated data is transmitted to a second transformer coil in the region of the kingpin of the semitrailer. A demodulator is provided in the semitrailer in order to separate the control data of the total signal transmitted by inductive coupling from an energy-carrying power supply voltage which is applied in order to supply power to a component on the power supply line of the semitrailer. In this context, in addition to transmitting the energy signal in the manner of a power line communication, the control data of the control device of the towing vehicle is modulated onto the carrier signal and transmitted in a wirefree fashion to the semitrailer. The demodulator then separates the control data again into the control data and the energy-carrying power supply voltage at the semitrailer side so that the total signal is used both to supply the component with current and to generate the control data for the components. This can be done without wirebound transmission from the towing vehicle to the semitrailer by inductive coupling between the two transformer coils. There is advantageously no need any longer for a plug-type connector to transfer the signals between the towing vehicle and trailer in a wirebound fashion.

In one development of the invention, the transformer coil in the fifthwheel pickup plate of the towing vehicle is a coil whose linear or curved longitudinal axis is arranged essentially parallel to the fifthwheel pickup plate. The transformer coil in the region of the kingpin of the semitrailer can also be a coil whose linear or curved axis is arranged essentially parallel to the plane of the fifthwheel pickup plate when the semitrailer train is coupled. As a result, the coil of the second transformer coil can also be arranged parallel to the coil of the first transformer coil so that optimal inductive coupling can take place. In one embodiment of the invention, the transformer coil can be curved in a U shape and be attached underneath or above the fifthwheel pickup plate, if appropriate in a groove. The second transformer coil is then preferably mounted in a groove on the kingpin of the semitrailer so that the transformer coils are arranged close to one another in the coupled state of the semitrailer train.

As an alternative to embodying the transformer coils in the form of coils it is possible for the transformer coils to be embodied as antennas which are arranged in the region of the fifthwheel pickup plate or on the semitrailer and to be designed to transmit the energy signal, which also functions as a carrier signal, to the semitrailer. On the semitrailer side, the received and demodulated control data is converted by a control device into the signals required in the semitrailer in terms of signal level and data format so that, for example, a CAN (Controller Area Network) data bus can transmit the control data to components such as brakes, flashing indicator lights, reversing light and similar components.

The scope of protection of the present invention also relates to the towing vehicle of the semitrailer train alone insofar as the towing vehicle is suitable for a semitrailer train according to the invention. The towing vehicle has a fifthwheel with fifthwheel pickup plate for forming a mechanical connection between the towing vehicle and semitrailer, a control device for controlling components of the semitrailer being provided on the towing vehicle.

A data line is provided for transmitting the control data to the semitrailer, and a power supply line is provided for transmitting the power supply of the components of the semitrailer. A voltage generator for generating a periodically fluctuating carrier signal is provided in the towing vehicle, and a first transformer coil is arranged in the region of the fifthwheel pickup plate of the towing vehicle in order to transmit the carrier signal in the region of a kingpin of a semitrailer in order to generate in the semitrailer an energy-carrying power supply voltage for a component in the semitrailer from the signal which is transmitted by inductive coupling.

The towing vehicle is characterized by the features which are necessary for the semitrailer train according to the invention. This includes the transformer coil in the region of the fifthwheel pickup plate, which is embodied as an antenna or coil with its linear or curved longitudinal axis being arranged essentially parallel to the plane of the fifthwheel pickup plate. In addition, the signal modulator is provided which modulates the control data onto the carrier signal. The total signal with the control data modulated onto it is then transferred to the semitrailer by means of inductive coupling via a transformer coil of the towing vehicle.

In addition to the towing vehicle, a semitrailer which is also used for use in the semitrailer train according to the invention with wirefree transmission of energy, if appropriate with modulated data communication, is also protected. According to the invention, the semitrailer is characterized in that a transformer coil is provided in order to generate, from the total signal which is transmitted by inductive coupling from a towing vehicle, an energy-carrying power supply voltage which is applied in order to supply power to a component on the power supply line of the semitrailer. The component is in particular a sensor or actuator which is necessary to operate the semitrailer. A demodulator is provided in the semitrailer in order to separate the control data of a towing vehicle for a component in the semitrailer in the total signal which is transmitted by inductive coupling. The power supply signal which is acquired in the semitrailer is preferably used to feed a battery which is charged by the energy-carrying power supply voltage.

The invention develops conventional semitrailer trains to the extent that the energy for components of the semitrailer is made available by of inductive coupling so that there is no need for an additional energy supply in the semitrailer. Furthermore, a control signal for controlling the components of the semitrailer can be modulated on and the control signal is used to actuate the components after the demodulation process. The control data includes, for example, switch-on and switch-off signals for a component but physical signals of a sensor in the towing vehicle are also transmitted in coded form to the component in the semitrailer. The modulation can, for example, be a frequency modulation or a pulse code modulation which is transmitted onto the preferably sinusoidal carrier signal, if appropriate with direct voltage superimposition.

There are various possible ways of advantageously configuring and developing the teaching of the present invention. In this respect, reference is made to the following explanation of an embodiment. The drawing illustrates an embodiment of the semitrailer train according to the invention. In the drawing, in each case in a schematic view.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 shows a semitrailer train with a fifthwheel and the wirefree signal transmission device which is arranged thereon, and

FIG. 2 shows a view of the fifthwheel pickup plate with a first transformer coil and the kingpin which is attached to the semitrailer and has a second transformer coil according to the present invention.

### DETAILED DESCRIPTION OF THE PREFERRED EMBODIMENTS

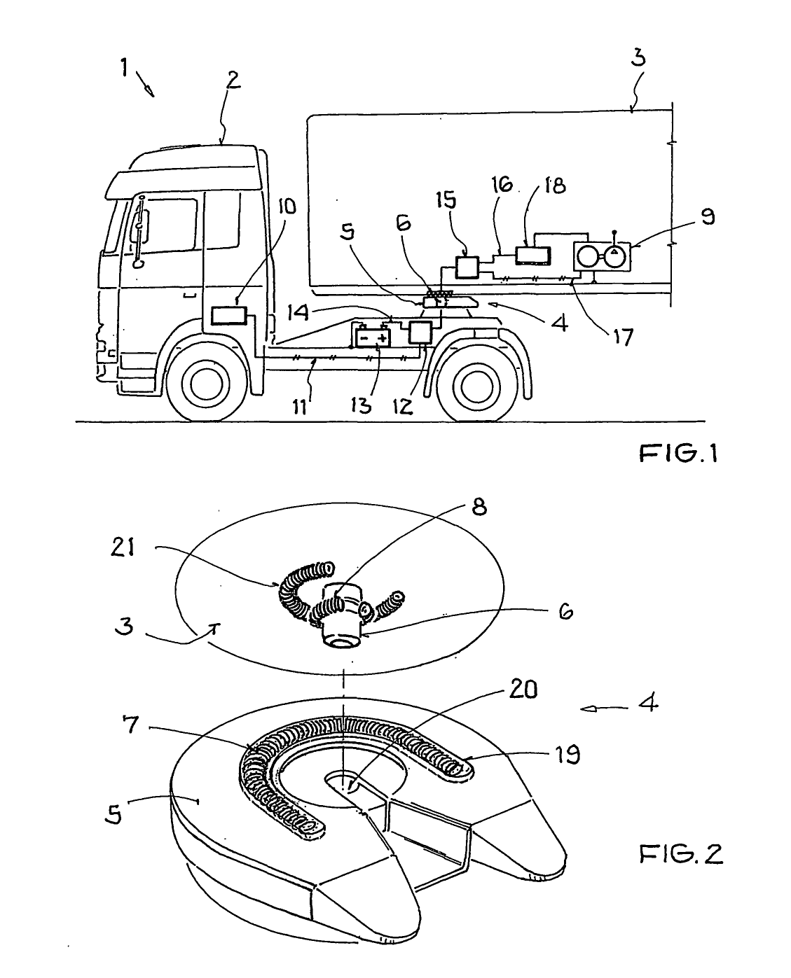

FIG. 1 shows a semitrailer train 1 with a vehicle 2 and a semitrailer 3 coupled thereto. A fifthwheel 4 is provided between the towing vehicle 2 and the semitrailer 3 in order to mechanically connect the towing vehicle 2 and semitrailer 3. The fifthwheel 4 is composed of a fifthwheel pickup plate 5 which is attached to the towing vehicle 2, and of a kingpin 6 which is attached to the semitrailer 3. A wirefree communications and energy transmission device, which is composed of a first transformer coil 7 and a second transformer coil 8, is provided in the region of the fifthwheel.

In order to actuate components 9 which are arranged inside the semitrailer 3, for example, an actuator such as a compressor for the brake system of the semitrailer 3 or a sensor which detects the temperature in the semitrailer. A control device 10 is provided in the towing vehicle 2. The control device 10 is coupled to other control devices via a data bus, for example a CAN data bus or a flex-ray data bus. The data bus 11 is additionally provided in order to transmit control data or control messages from the control unit 10 to a control device 12 which is coupled to the first transformer coil 7. The transformer coil 7 is fed via the control device 12 with an energy signal or carrier signal from a battery 13 so that the energy signal or carrier signal at the first transformer coil 7 can be transmitted to the second transformer coil 8 in the region of the kingpin 6. A power supply line 14 is mounted in the towing vehicle 2 between the battery 13 and the control device 12 or the transformer coil 7.

A further control device 15, which is arranged inside the semitrailer 3, is connected to the second transformer coil 8. The component 9 is supplied with energy via the power supply line 16, while the control data is connected to the component 9 via a data bus 17 or a corresponding actuation line.

Control data for controlling, for example, the brake system or the brake lights is provided in the control device 10 of the towing vehicle 2 and transmitted to the component 9 in the region of the semitrailer 3. In the first embodiment of the present invention, only the energy-carrying component, i.e. the battery signal is transmitted from the battery 13 to the component 9 via the transformer coils 7, 8. As a result, a power supply voltage in the semitrailer by means of a separate accumulator can ideally be dispensed with. The transformer coil 7 receives a periodically fluctuating energy signal via the control device and the assigned battery 13, the two transformer coils 7, 8 interacting like a transformer so that only an alternating voltage is applied to the transformer coil 8 by inductive coupling.

The periodically fluctuating energy signal can in the simplest case be an inverted signal, for example a sinusoidal alternating voltage signal. Alternatively, the periodically fluctuating energy signal can also be a direct voltage signal which is produced a direct voltage signal superimposed on an inverted signal so that the sinusoidal signal fluctuates only between the zero potential and the potential of the battery 13. Only an alternating voltage signal is present on the semitrailer 3 side as a result of the inductive coupling at the transformer coil 8. The alternating voltage signal can then be rectified, for example at the control device 15, in order, for example, to actuate other control devices 18 inside the semitrailer with direct voltage. The component 9 is, for example, a compressor which is operated by alternating current for the brake pressure booster in the semitrailer.

In an alternative embodiment of the present invention, the energy signal is simultaneously a carrier signal and a voltage which has the information of the control data of the control device 10 is modulated onto this periodically fluctuating carrier signal. For this purpose, a modulator is additionally provided in the control device 12 in order to modulate the control data of the data bus 11 onto the carrier signal in a suitable form, for example by frequency modulation or pulse modulation. A demodulator, which separates the inductive total signal which is received by the transformer coil 8 back into the control data on the data line 17 and the energy supply current on the power supply line 16 by demodulation is then provided inside the control device 15 in the semitrailer 3.

The fifthwheel 4 is illustrated in more detail in FIG. 2. The first transformer coil 7 is arranged in a groove 19 on the upper side of the fifthwheel pickup plate 5 and is molded, for example, by means of a plastic. The groove is open at the top and given a U shape in order to accommodate a coil or an antenna which is curved in a U shape. A groove, for example an annular groove, in which the second transformer coil 8 is provided in the form of a further coil or an antenna, is also arranged on the kingpin 6 of the semitrailer 3. If the kingpin 6 is secured in the coupled position in the corresponding receptacle 20 on the fifthwheel pickup plate 5, the coil 8 is located in the direct vicinity of the U-shaped coil 7 within the fifthwheel pickup plate 5.

As a first alternative, the second transformer coil 8 can also be provided, as illustrated at 21, as a coil which is arranged on a mounting plate underneath the semitrailer 3 and is then arranged directly above the fifthwheel pickup plate, if appropriate in a groove underneath the semitrailer 3. A further alternative is to arrange the first transformer coil 7 on the underside of the fifthwheel pickup plate and to arrange it inside the free installation space in the fifthwheel pickup plate 5 in such a way that in the coupled state of the fifthwheel 4 the first transformer coil is arranged next to the second transformer coil 8 on the kingpin 6 of the semitrailer 3. In this alternative, the fifthwheel pickup plate 5 can then be arranged above the first coil 7 and be provided to get as a shielding housing so that the inductive coupling is reflected by the shielding effect within the housing and the inductive coupling is provided exclusively by means of the second transformer coil 8. Since the fifthwheel pickup plate 5 is then arranged around the coil 7, the electromagnetic waves are then shielded and received only at the second transformer coil 8.

According to the present invention, a towing vehicle which is suitable for wirefree communication and a semitrailer which is suitable for that purpose are placed under protection. An advantage of the present invention is that plug-type connectors both for transmitting data and for transmitting energy can be dispensed with since the signals are transmitted to the semitrailer of the semitrailer train 1 by inductive coupling.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A semitrailer train comprising:
a towing vehicle;
a semitrailer;
a control device for controlling components of the semitrailer being provided in the towing vehicle;
data lines in the semitrailer for transmitting the control data and power supply lines for supplying power to the components;
a voltage generator for generating a periodically fluctuating carrier signal provided in the towing vehicle, wherein a signal modulator modulates the control data onto a carrier signal;
a demodulator in the semitrailer separates a total signal which is transmitted by inductive coupling into a carrier signal and includes the control data with the control data being provided for actuating said components in the semitrailer;
a fifthwheel of the towing vehicle and a coupling part of the semitrailer form a mechanical connection between the towing vehicle and semitrailer, wherein the coupling part of the towing vehicle is a fifthwheel pickup plate and the coupling part of the semitrailer is a kingpin which fits with said coupling part; and
a first transformer coil arranged in the fifthwheel pickup plate of the towing vehicle in order to transmit the data modulator carrier signal to a second transformer coil proximal to the kingpin of the semitrailer wherein the first transformer coil in the fifthwheel pickup plate of the towing vehicle is a coil whose linear or curved longitudinal axis is arranged substantially parallel to the plate of the fifthwheel pickup plate.

8. A semitrailer train comprising:
a towing vehicle,
a semitrailer;
a control device for controlling components of the semitrailer being provided in the towing vehicle;
data lines in the semitrailer for transmitting the control data and power supply lines for supplying power to the components,
a voltage generator for generating a periodically fluctuating carrier signal provided in the towing vehicle, wherein the carrier signal is transmitted by inductive coupling as a power supply voltage for said components in the semitrailer;
a fifthwheel of the towing vehicle and a coupling part of the semitrailer form a mechanical connection between the towing vehicle and the semitrailer, wherein the coupling part of the towing vehicle is a fifthwheel pickup plate and the coupling part of the semitrailer is a kingpin which fits with said coupling part, and
a first transformer coil arranged in the fifthwheel pickup plate of the towing vehicle in order to transmit the carrier signal to a said transformer coil proximal to the kingpin of the semitrailer wherein the first transformer coil in the fifthwheel pickup plate of the towing vehicle is a coil whose linear or curved longitudinal axis arranged substantially parallel to the plane of the fifthwheel pickup plate.

9. The semitrailer train as claimed in claim 7, wherein the semitrailer includes a rectifier which converts the carrier signal into direct current whereby the components of the semitrailer are supplied with direct voltage.

10. The semitrailer train as claimed in claim 7, further comprising a third transformer coil proximal to the kingpin of the semitrailer whose linear or curved longitudinal axis is arranged essentially parallel to the plane of the fifthwheel pickup plate when the semitrailer train is coupled.

11. A towing vehicle arrangement comprising:
a fifthwheel having a fifthwheel pickup plate for forming a mechanical connection between a towing vehicle and a semitrailer;
a control device in the towing vehicle for controlling components of the semitrailer data lines for transmitting control data to the semitrailer;
power supply lines for supplying power to the components of the semitrailer;
an alternating voltage generator with towing vehicle for generating a carrier signal wherein a signal modulator modulates the control data onto the carrier signal,
a first transformer coil is arranged in the fifthwheel pickup plate of the towing vehicle in order to transmit the modulated carrier signal to a second transformer coil proximal to a kingpin of the semitrailer in order to generate in the semitrailer a carrier signal and control data for said components in the semitrailer from the signal which is transmitted by inductive coupling wherein the first transformer coil in the fifthwheel pickup plate of the towing vehicle is a coil whose linear or curved longitudinal axis is arranged substantially parallel to the plane of the fifthwheel pickup plate.

12. A semitrailer arrangement for a semitrailer train comprising:
a kingpin for coupling to a coupling part of a towing vehicle;
a control device for the towing vehicle for actuating components of the semitrailer;
data lines in the semitrailer for transmitting the control data, and power supply lines for supplying power to the components;
a demodulator which separates a total signal transmitted from the towing vehicle by inductive coupling into an energy-carrying power supply voltage and the control data which is provided in the semitrailer, the power supply voltage being provided to supply power to said components in the semitrailer; and
a transformer coil proximal to the kingpin of the semitrailer whose linear or curved longitudinal axis is arranged substantially parallel to the plane of the fifthwheel pickup plate when the semitrailer train is coupled.

13. The semitrailer train as claimed in claim 8, wherein the semitrailer includes a rectifier which converts the carrier signal into direct current whereby the components of the semitrailer are supplied with direct voltage.

14. The semitrailer train as claimed in claim 8, further comprising a third transformer coil proximal to the kingpin of the semitrailer whose linear or curved longitudinal axis is arranged essentially parallel to the plane of the fifthwheel pickup plate when the semitrailer train is coupled.

15. The semitrailer train as claimed in claim 9, further comprising a third transformer coil proximal to the kingpin of the semitrailer whose linear or curved longitudinal axis is arranged essentially parallel to the plane of the fifthwheel pickup plate when the semitrailer train is coupled.
